(19) United States
(12) Patent Application Publication
(10) Pub. No.: US 2013/0313035 A1
(43) Pub. Date: Nov. 28, 2013

(54) REGENERATION SYSTEM FOR A VEHICLE

(71) Applicant: AMERICAN SPORTWORKS LLC, Fort Wayne, IN (US)

(72) Inventor: Philip JOSEPH JENKINS, JR., Ponchatoula, LA (US)

(21) Appl. No.: 13/951,113

(22) Filed: Jul. 25, 2013

Related U.S. Application Data
(63) Continuation-in-part of application No. 13/798,646, filed on Mar. 13, 2013.
(60) Provisional application No. 61/676,099, filed on Jul. 26, 2012.
(60) Provisional application No. 61/611,707, filed on Mar. 16, 2012.

(51) Int. Cl. B60K 6/52; B60K 6/485

(52) U.S. Cl. CPC B60K 6/52; B60K 6/485; Y10S 903/951
USPC 180/243; 180/65.26; 903/951

(57) ABSTRACT

A dual-powered utility vehicle that includes a gasoline engine configured to rotate a first axle that rotates at least a first wheel; an electrical motor configured to rotate a second axle that rotates at least a second wheel; and at least one battery. The at least second wheel also rotates the second axle. The at least one battery is connected to the electrical motor. The vehicle is configured such that when being moved under power from the gasoline engine, the at least second wheel of the electrical drive train is rotated by virtue of its ground contact when the gasoline engine rotates the at least first wheel. Energy created by the at least second wheel rotating is transferred to the at least one battery to recharge the battery and make available for use by the electrical motor to rotate the at least one second wheel when activated to do so.

### RELATED APPLICATIONS

The present application is a continuation-in-part to U.S. Utility patent application Ser. No. 13/798,646, filed on Mar. 13, 2013, entitled “Hybrid Utility Vehicle With Selectable Drivetrain” which claims benefit of U.S. Provisional Patent Application, Ser. No. 61/611,707, filed on Mar. 16, 2012, entitled “Hybrid Utility Vehicle with Selectable Drivetrain.” The present application also claims benefit of U.S. Provisional Application 61/676,099, filed on Jul. 26, 2012, entitled “Regeneration System For a Vehicle.” The subject matter disclosed in these applications is hereby expressly incorporated into the present application.

### SUMMARY

The following disclosure relates to a utility vehicle. More particularly, this disclosure relates to a utility vehicle having both electrical and internal combustion means for it to move from one location to another.

The utility vehicle of the present disclosure is used for personal transportation and light hauling applications. They are not utility automobiles or trucks. Instead, these utility vehicles are typically employed in off-road type applications to carry persons and materials from one location to another. The utility vehicle of the present disclosure includes gas and electrical power modes of moving. In such off-road applications it may be beneficial to employ either an internal combustion engine or an electric power motor. On one hand, when low noise is needed for short distant travel, approximately 13 miles for example, the electric motor is available. On the other hand, for longer travel, such as 80 miles without refueling, or where more power is needed, the internal combustion engine is available.

Another illustrative embodiment of this present disclosure includes the utility vehicle also having the ability to employ four wheel drive using both the gasoline and electric motors. The drivetrain is selectable so that two wheels are moved using the gasoline engine and the other two wheels are moved using the electric motor. In another illustrative embodiment, the operator has the option to select between any of these drivetrain modes. Illustratively, the electric motor may be located towards the front of the vehicle and is configured to move the front wheels. The gasoline engine may be located towards the rear of the vehicle and configured to move the rear wheels. It is appreciated that the location of the particular motor, either gasoline or electric, may be either rearward or forward depending on the particular application for the utility vehicle. In an illustrative embodiment, when the gasoline engine drivetrain is selected, the utility vehicle becomes a rear-wheel drive vehicle. Conversely, when the electric motor drivetrain is selected, the utility vehicle becomes a front-wheel drive vehicle. When the 4×4 drivetrain is selected, both the gas and electric motors are running concurrently moving all four wheels. Separate throttle cables, one for the gas engine and for the electric motor, are simultaneously tuned through a potentiometer that feeds the electric motor controller to keep the dual drivetrains at the same revolutions per minute (RPMs).

In another illustrative embodiment, a regenerative braking system is employed that not only stops the vehicle, but helps recharge the batteries. The energy created by the electric motor now being turned by the tires contacting the ground is captured to help charge the batteries. As soon as the throttle pedal is released, the electric motor is now not under any load from the batteries. The rotating tires rotate the axle and gearbox which turns the motor creating a voltage to charge the battery pack. Having separate drivetrains gives the vehicle the ability to take the load off of the electric motor and drive the vehicle with the rear gas engine. This propels the vehicle rotating the front tires allowing the electric motor to fully charge the battery pack.

Another illustrative embodiment provides a dual-powered utility vehicle. This vehicle comprises a gasoline engine and an electrical motor. The gasoline engine is configured to drive at least a first wheel at first revolutions per minute. The electrical motor is configured to drive at least a second wheel at second revolutions per minute. A throttle is configured to affect the gasoline engine and the electric motor separately, or both the gasoline engine and electric motor simultaneously. An electrical motor controller is configured to control the electric motor. A potentiometer is in communication with both the electrical motor controller and the throttle. Under a gasoline engine power-only condition, the throttle affects the gasoline engine to affect the first revolutions per minute of the at least first wheel. Under an electrical motor power-only condition, the throttle affects the electrical motor to affect the second revolutions per minute of the at least second wheel. Under a dual-power condition, the throttle affects the electrical motor and the gasoline engine to rotate the at least first wheel and the at least second wheel simultaneously; wherein the potentiometer is configured to send a signal to the motor controller so the electrical motor will maintain the second revolutions per minute of the at least second wheel to be the same as the first revolutions per minute of the at least first wheel.

In the above and other illustrative embodiments, the dual-powered utility vehicle may further comprise: a battery configured to supply power to the electrical motor; the potentiometer being configured to send a signal from the throttle to the electrical motor controller to cause the motor to increase or decrease the second revolutions per minute of the at least second wheel; the electrical motor controller being in communication with both a contactor and at least one battery to direct either more or less power to the electrical motor; the electrical motor being located at a forward portion of the utility vehicle and the gasoline engine being located at a rearward portion of the utility vehicle; the electrical motor being configured to rotate at least one front wheel, and wherein the gasoline engine being configured to rotate at least one rear wheel; a throttle pedal wherein the throttle pedal is in communication with the potentiometer and the gasoline engine; a throttle cable coupled to the throttle pedal and potentiometer, wherein an amount of throttle cable travel is detected by the potentiometer which converts that detection into an electronic signal which is sent to the electrical motor controller to regulate speed of the electrical motor; the electrical motor controller being configured to regulate the second revolutions per minute of the at least one second wheel and a regenerative braking system; a plurality of 12-volt batteries wired in series and in communication with the electrical motor controller and the electrical motor; the electrical motor is a 48-volt DC motor; a controller in communication with the potentiometer and configured to initiate modes selected from the group consisting of on/off, forward/neutral/reverse, and regeneration/drive; and the regeneration/drive mode determines whether batteries used to power the electrical motor will recharge for use later.

Another illustrative embodiment of a dual-powered utility vehicle comprises: an electrical motor drivetrain that includes an electrical motor configured to drive at least one wheel; a gasoline engine drivetrain that is configured to drive at least another wheel; a throttle configured to operate the gasoline engine drivetrain and the electric motor drivetrain; a regenerative braking system that helps recharge a battery used with the electrical motor drivetrain: wherein under a non-electrical motor power drive condition, the electrical motor is configured to rotate when the utility vehicle is being propelled by another power source, and as the wheel contacts the ground and rotates, it captures electrical energy and stores the electrical energy in a battery.

In the above and other embodiments, the dual-powered utility vehicle may further comprise: when the throttle is disengaged, the electrical motor is under no load from the battery, wherein the rotating wheel turns the motor creating a voltage that charges the battery; the gasoline engine drivetrain is configured to take a load off of the electrical motor when the gasoline engine drivetrain is engaged allowing the electrical motor to recharge the battery; when the wheel rotates, the electrical motor drivetrain is disengaged which causes an axle and gearbox to rotate which rotates the electrical motor which creates a voltage to charge the battery.

Another illustrative embodiment provides a dual-powered utility vehicle that comprises, a gasoline engine configured to rotate a first axle that rotates at least a first wheel; an electrical motor configured to rotate a second axle that rotates at least a second wheel; and at least one battery. The at least second wheel also rotates the second axle. The at least one battery is connected to the electrical motor. The vehicle is configured such that when being moved under power from the gasoline engine, the at least second wheel of the electrical drive train is rotated by virtue of its ground contact when the gasoline engine rotates the at least first wheel. Energy created by the at least second wheel rotating is transferred to the at least one battery to recharge the battery and make available for use by the electrical motor to rotate the at least one second wheel when activated to do so.

In the above and other embodiments, the dual-powered utility vehicle may further comprise: an electrical motor controller configured to control the electric motor; and a controller in communication with the motor that includes a regeneration mode that causes any energy created by rotation of the at least second wheel to transfer to the at least one battery to recharge the battery.

Additional features and advantages of the utility vehicle will become apparent to those skilled in the art upon consideration of the following detailed descriptions exemplifying the best mode of carrying out the utility vehicle as presently perceived.

### BRIEF DESCRIPTION OF THE DRAWINGS

The present disclosure will be described hereafter with reference to the attached drawings which are given as non-limiting examples only, in which:

FIG. 1 is a side view of dual-powered utility vehicle;

FIG. 2 is a side view of another embodiment of a dual-powered utility vehicle;

FIGS. 3a through c are exploded views of the dual-powered utility vehicle of FIG. 2;

FIGS. 4a and b are exploded diagram views of the front and rear drivetrain portions, respectively;

FIG. 5 is another side view of the dual-powered utility vehicle of FIG. 2; and

FIGS. 6a and b are partially exploded perspective views of electric and gasoline drive trains.

Corresponding reference characters indicate corresponding parts throughout the several views. The exemplification set out herein illustrates embodiments of the utility vehicle, and such exemplification is not to be construed as limiting the scope of the utility vehicle in any manner.

### DETAILED DESCRIPTION

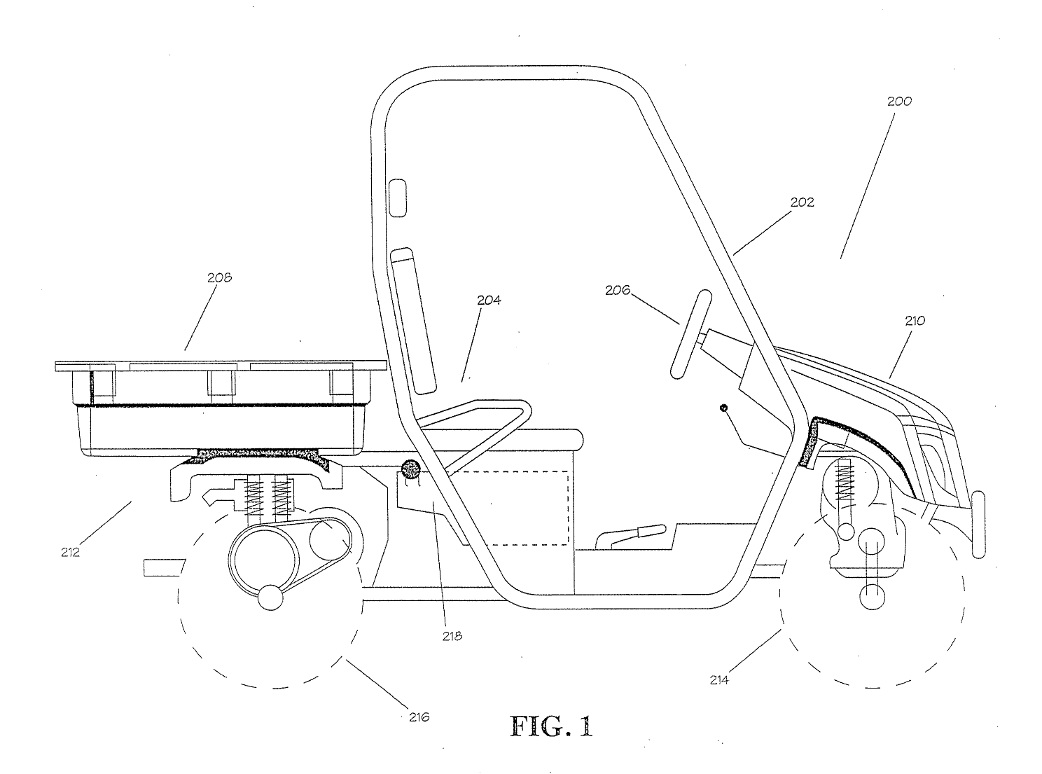

A side view of a dual-powered utility vehicle 200 is shown in FIG. 1. Vehicle 200 includes a cab section 202 with a seat portion 204 and steering assembly 206. A cargo area 208 is illustratively positioned behind cab section 202. In this illustrative embodiment, vehicle 200 is powered via an electric motor located at the forward section 210 and an internal combustion gasoline engine located at the rearward portion 212. Further illustratively, the electric motor is configured to rotate front wheels 214 while the gasoline engine is illustratively configured to rotate rear wheels 216. As shown in this view, a tank 218 is accessible exterior of the vehicle to fill with gasoline.

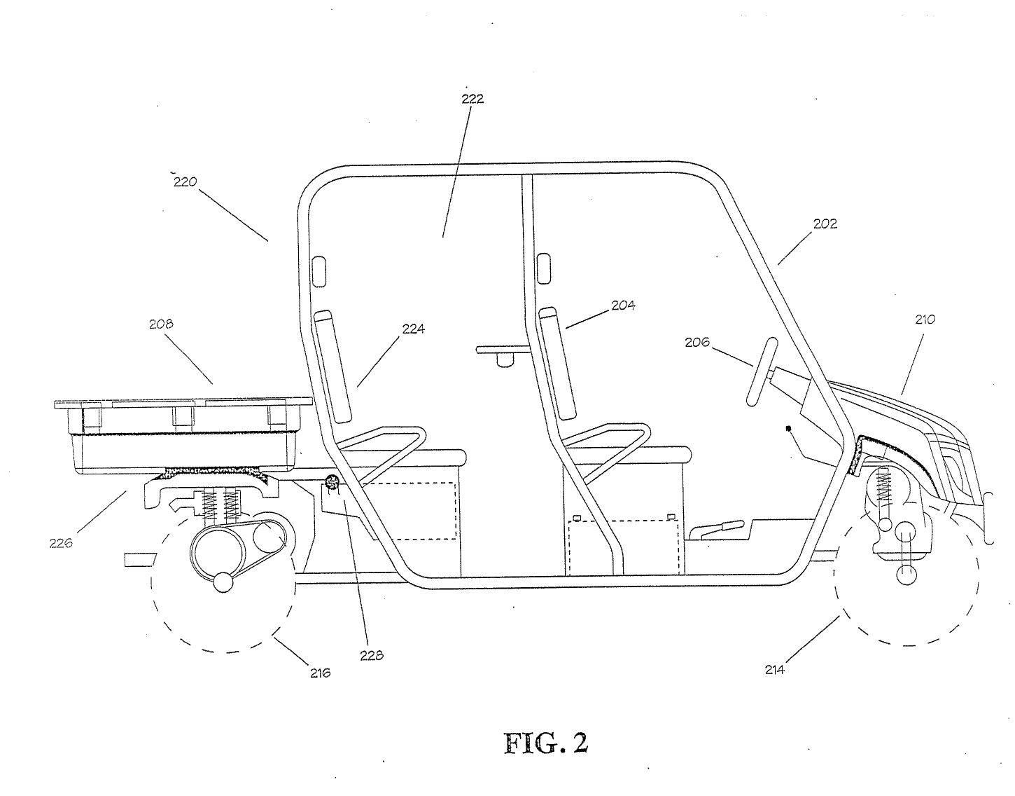

Another side view of a dual-powered utility vehicle 220 is shown in FIG. 2. Vehicle 220 is similar to that of vehicle 200, having a similar cab section 202 with steering column 206 and seat 204. In contrast, however, this embodiment includes a rear seat 224 located in rear seat section 222. In this illustrative embodiment, there is a similar forward section 210 and cargo area 208. It is appreciated, however, that the sizing of these areas may be changed for use with a dual row seat utility vehicle. In other words, the forward section 210 may be sized larger or smaller as needed. Likewise, cargo area 208 may be sized larger or smaller depending upon the needs of the vehicle. Front wheels 214 and rear wheels 216, likewise, may be the same size, or sized larger or smaller than what is used on utility vehicle 200 depending upon the needs of vehicle 220. Adjacent rearward portion 226 is fuel tank 228, correspondingly located to that shown with respect to utility vehicle 200 of FIG. 1. The internal combustion engine and the electric motor discussed herein will be described illustratively with respect to vehicle 220. It should be appreciated, however, that the concepts described with respect to vehicle 220 apply likewise to vehicle 200. It is also appreciated that the engine, motor, drivetrain, and other components employed to move these vehicles may be appropriately sized and configured to accommodate the size and weight of the vehicle.

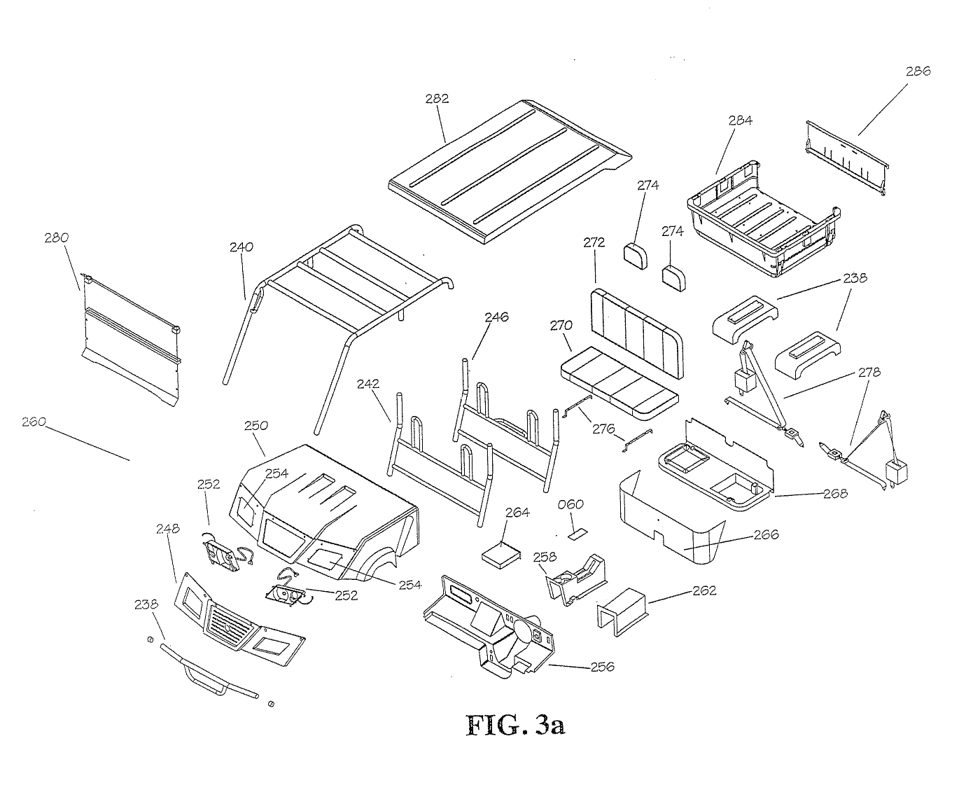

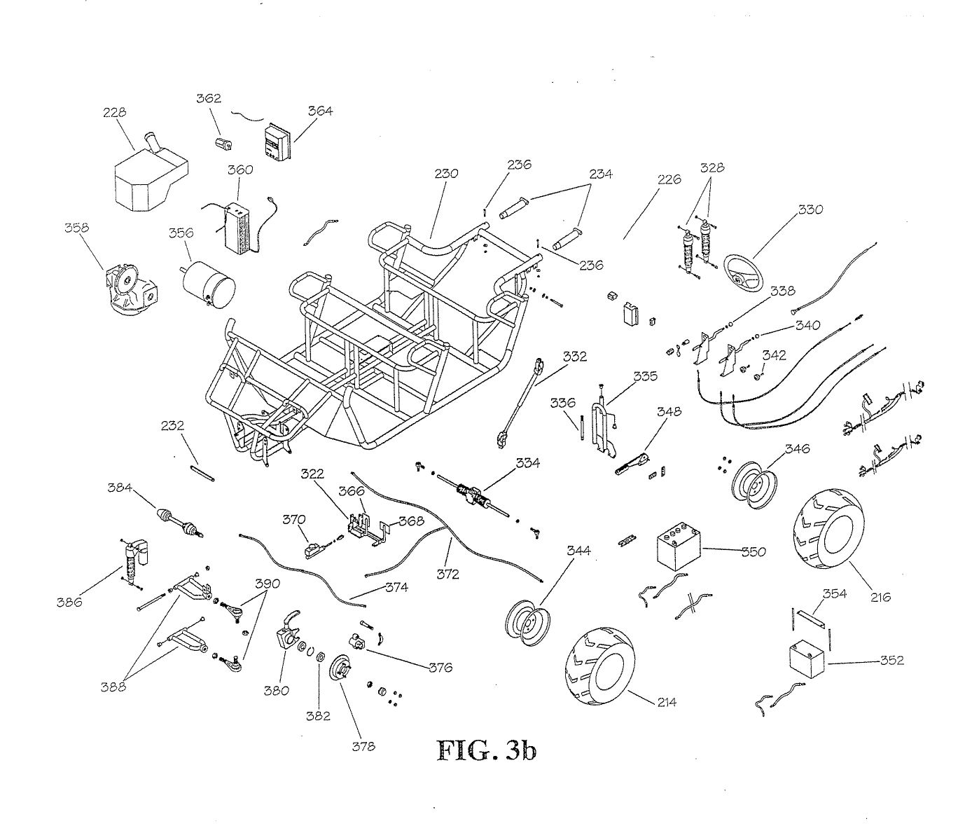

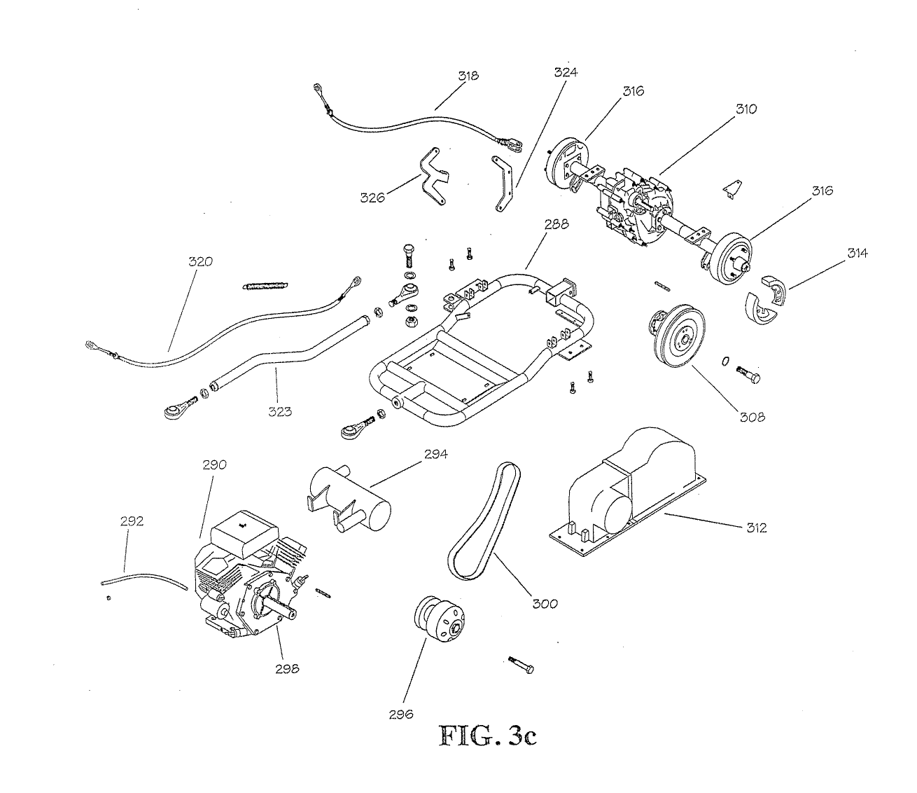

An exploded view of vehicle 220 is shown in FIGS. 3a through 3c. Frame 230 serves as the foundation of vehicle 220. A tie bar 232 illustratively attaches to the front of frame 230 to secure portions of the same together. Rear frame stubs 234 illustratively attach to frame 230 via fasteners 236 as shown. A front bumper 238 is likewise attachable to frame 230. A top frame or brush guard 240 is attachable to the frame to begin forming passenger compartments 202 and 222. Frame 230 is further supplemented by seat back frames 242 and 246, as illustratively shown. A grill 248 may be attached to frame 230 and positioned adjacent bumper 238 and hood 250. Shown are illustrative three-bulb headlight assemblies 252 that fit within openings 254 and hood assembly 250. A dashboard 256 fits in passenger compartment 202 adjacent hood 250 opposite headlamps 252. A center front console 258 is locatable in front passenger compartment 202. Cover 260 may attach to console 258 as needed. A rear console 262 is locatable in rear passenger compartment 222. A glove box 264 may be positioned in dashboard 256.

A seat wrap 266 depends from a seat support/storage space 268. Wrap 266 may illustratively be made of plastic. Seat cushions 270 with seat back rest 272 may be positioned on support 268 along with head rest 274. Seat bars 276 may illustratively be used to attach cushion 272 to support 268. In the illustrative embodiment, seat belt assemblies 278 may be attached to frames 230 and 242 to provide appropriate restraint for passengers inside the vehicle. It is appreciated that structures 266 through 278 may be duplicated in rearward compartment 222 for accommodating additional passengers. Windshield 280 attaches to frame 230 along with roof 282. A dump bed 284 with attachable tail gate 286 attaches to frame 230 along with rear fenders 238.

The gasoline-fueled internal combustion engine portion that moves vehicle 220 is attached to rearward portion 226. A support frame 288 is illustratively provided to support internal combustion engine 290. In an illustrative embodiment this engine may be a Subaru V-Twin 653 cc engine. A fuel hose 292 extends from engine 290 to fuel tank 228 creating a fluid flow path therebetween. A muffler, such as a 653 cc Subaru muffler 294, is also attached to engine 290 for handling the engine exhaust. A driver power block 296 attaches to drive rod 298 of engine 290. Block 296 rotates moving belt 300 which drives drive block 302 to rotate transaxle 310 and wheels 216 attached thereto. A belt guard 312 shrouds blocks 296, 308, and belt 300 to protect the same from the environment, Brake shoes 314 act on rotors 316 of transaxle assembly 310 to selectively stop utility vehicle 220. Brake cable 318 controls the braking operation of vehicle 220. Throttle cable 320 is connected to the pedal assembly 322 to control speed. Panhard 323 and its associated couplings attach to frame 288 to keep transaxle 312 from shifting from side to side. Stick shift 324 and its cable mount 326 moveably engage the transaxle to change the gears vehicle 220 operates on. Shock absorbers 328 couple to both frames 230 and 288 to reduce vibration in vehicle 220 while moving. Steering wheel 330 attaches to steering wheel shaft 332 which itself attaches to rack and pinion assembly 334 which couples to front wheels 214 to steer vehicle 220. Steering stub shaft 336 and steering support 335 assist in steering vehicle 220.

A differential control assembly 338 allows the operator to manually lock the rear axle giving power to both rear tires. A shifter assembly 340 allows the operator to manually select forward, neutral, or reverse in transaxle 310. Illustratively, a key switch 342 is in communication with the motors to turn them on and off. Illustratively two separate keyswitches, one for gas and one for electric, may be employed. Illustratively, switch 342 may have a parental lockout to keep children from turning on the engine. This view also shows rims 344 and 346 which fit into wheels 214 and 216, respectively. Parking brake 348 is tied to the braking system. Actuation of this lever activates and deactivates the brakes to keep the vehicle still while parked. Batteries 350 and 352 may be secured to vehicle 220 illustratively via a battery strap 354. These batteries 350 and 352 are connected to electric motor 356 to supply the power for vehicle 220. A gear box 358 sends power from the motor to the axles, potentiometer 360 which converts the throttle cable travel into an electronic signal is received by a motor controller 364 to regulate motor speed. A contactor 362 serves as a large relay connecting the 48 volts from the batteries to motor controller 364. Likewise, motor controller 364 is an electronic programmable controller that regulates all the several aspects of the motor including the RPMs, regenerative braking, etc.

Pedal assembly 322 includes a gas pedal 366 and brake pedal 368. Gas pedal 366 is in communication with potentiometer 360, as well as throttle control bracketing on the gas engine, to keep the electric motor and gas engine at the exact same RPM. Brake pedal 368 is in communication with master cylinder 370 rear brake hose 372 and front brake hose 374 to engage the vehicle's brakes. Brake calipers 376 engage rotor 378 which is coupled to tire 214 to selectively brake vehicle 220. Spindle weld assembly 380 and front spindle bearing 382 mount onto front axle 384 rotatably securing the wheels onto the vehicle. It is appreciated that the description of these brakes and wheel components can be employed on the other wheels as well. Shock absorber 386 couples to axle 384 and frame 230 to dampen the bumps and vibrations transferred through the wheels from the ground surface. A-arms 388 and heim joints 390 are attached to the frame to allow the suspension to travel across rough terrain.

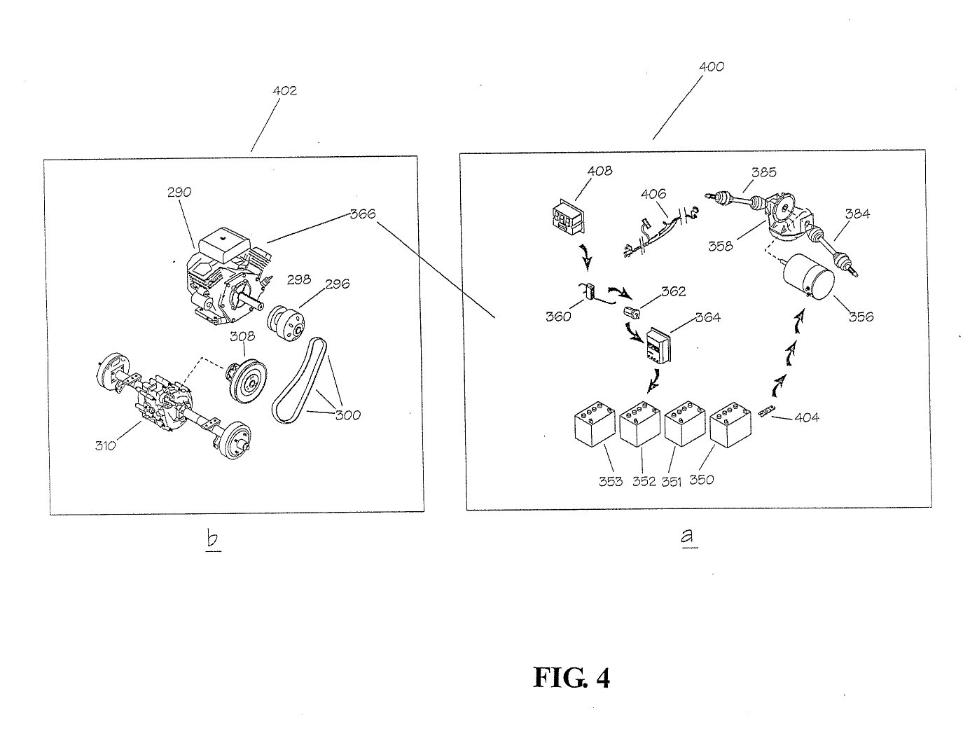

Exploded diagram views of front drivetrain 400 and rear drivetrain 402 are shown in FIGS. 4a and b, respectively. As shown in FIG. 4a, four 12-volt batteries, such as batteries 350, 351, 352, and 353 are wired in series. They are connected to an illustrative 48 volt DC motor, such as motor 356. Illustratively a 500 amp fuse 404 is located therebetween to prevent power surges from damaging motor 356. As shown herein, motor 356 drives gear box 358 tied to axles 384 and 385. Illustratively, a wiring harness array 406 couples all the electrical components together. A controller box 408 located in the passenger compartment includes on/off, forward/neutral/reverse, and regeneration/drive mode switches. The on/off switch obviously selectively powers the electric motor. The forward/neutral/reverse switch causes gear box 358 to change the direction of the wheels either in forward or reverse, or disengages to a neutral mode. Lastly, the regeneration/drive mode determines whether the batteries will be used to power motor 356 or be recharging themselves for use later. Potentiometer 360 is tied to both motor controller 364 and throttle pedal 366 (see, also, FIG. 3) and is used to send a signal from the pedal to the motor 356 which rotates the wheels faster or slower. Motor controller 364 is in communication with both contactor 362 and batteries 352 to direct more or less power to motor 356. This, in effect, causes vehicle 220 to accelerate or decelerate.

Illustratively, at the rear of vehicle 220, as shown in FIG. 4b, is gasoline engine 290 which rotates drive rod 298 which rotates constant velocity torque converter driver clutch 296 which, when coupled to belt 300, rotates constant velocity torque converter driven clutch 308. This drives transaxle 310 which in turn rotates the rear wheels. Accelerator pedal 366 is connected to engine 290 via a throttle cable to accelerate or decelerate motor 290.

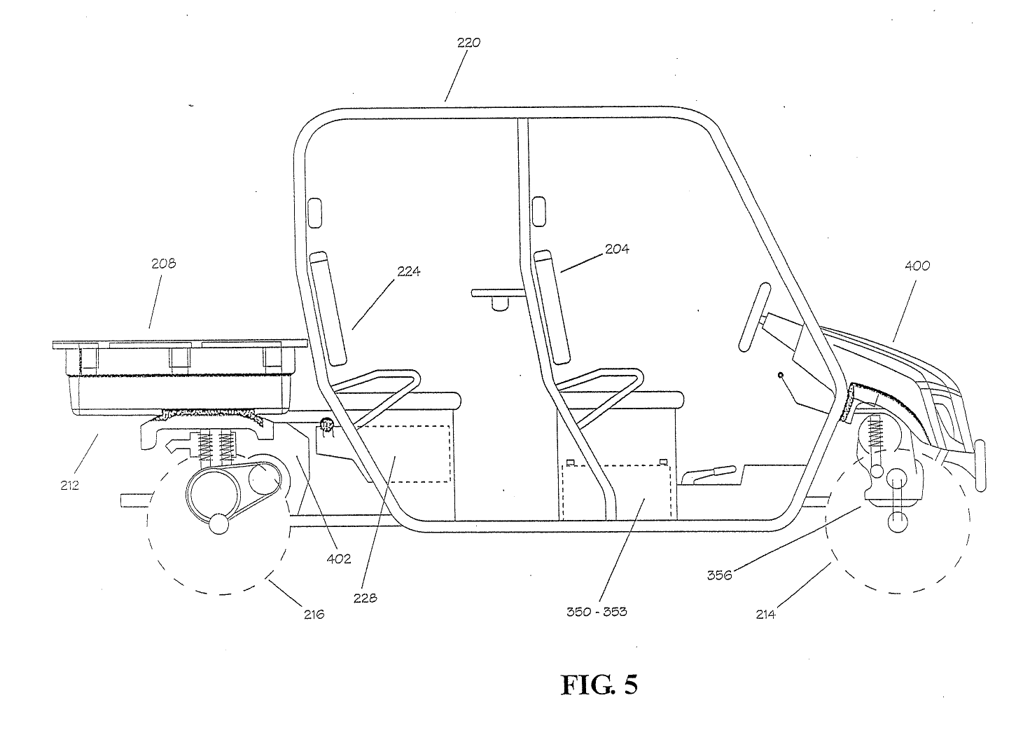

Another side view of vehicle 220 is shown in FIG. 5. This view shows wheels 214 and 216 in phantom view to better demonstrate the relative locations of electric motor assembly 400 and gasoline drive assembly 402, respectively. As shown, motor assembly 400 and associated components (see, also, FIGS. 3 and 4) are located at front end 210 of vehicle 220. Batteries 350 through 353 may be illustratively located under seat portion 204. This arrangement efficiently uses space on vehicle 220 while not deviating from the normal look and feel of a conventional utility vehicle. Gas tank 228, such as a five gallon gas tank, is shown illustratively located under rear seat 224 and is in fluid communication with engine assembly 402 located under cargo area 208 at rear portion 212 of vehicle 220.

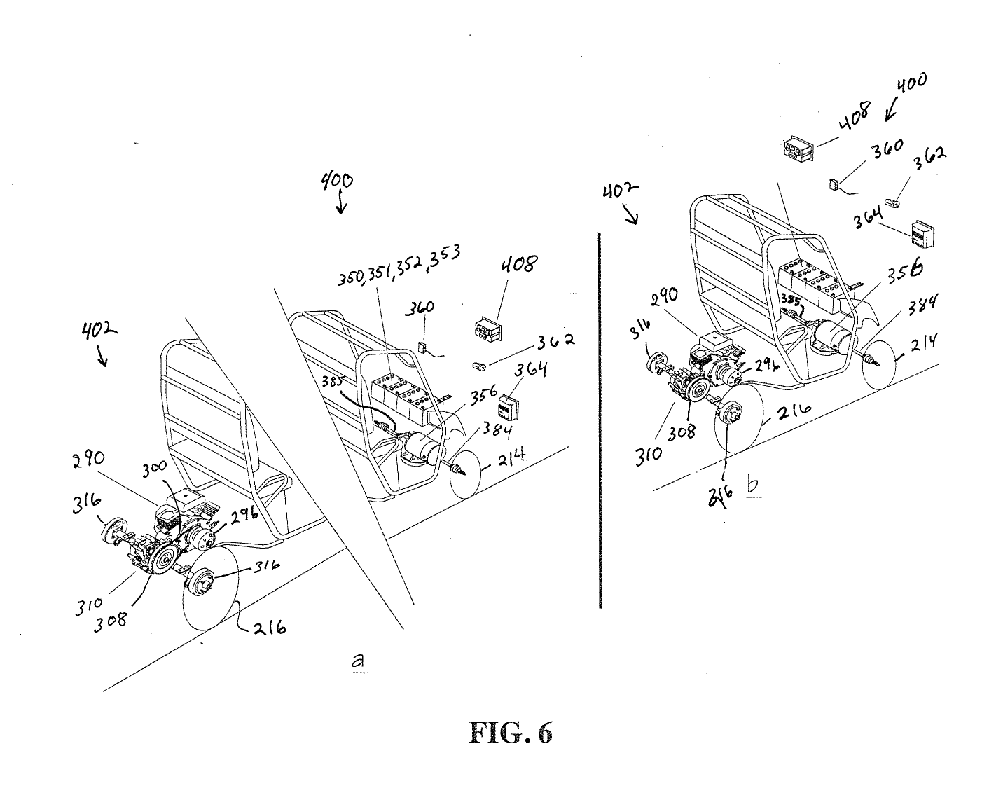

The drive trains 400 and 402, shown in FIGS. 6a and b, are usable on both prior disclosed vehicles 200 and 220. It is appreciated that electric and gasoline drive trains 400 and 402, respectively, are separate drive trains on a singe vehicle. In other words, a vehicles' electric and gasoline motors do not share one drive train. As shown in FIG. 6a for example, the front wheels are driven by gasoline engine 290 located illustratively adjacent the gasoline-engine-driven transaxle 310. Separately, an electric motor 356 and batteries 350, 351, 352, and 353 are illustratively located adjacent an electric motor-driven axles 384, 385. When the vehicle is in “regen mode,” by activating that function on controller box 408, gasoline engine 290 is propelling the vehicle. When this happens wheels 214 connected to electric motor-driven axles 384, 385, still rotates. But these rotating wheels 214 are not driving the vehicle like the gasoline-driven wheels 216. Instead, rotating electrically-drive wheels 214 create energy which is sent to batteries 350, 351, 352, and 353 to recharge the same. This is because electric motor-driven axles 384 and 385 are rotating in response to the gasoline-engine-driven wheels 216 instead of driving the wheels. The rotating axles 384 and 385 are used exclusively to recharge batteries 350, 351, 352, and 353 instead of propelling the vehicle. Power for electric motor 356, thus, becomes available to rotate the electric-driven wheels 214 when activated. The view in FIG. 6b shows both the separate electric and gasoline drive trains on a single vehicle.

Corresponding reference characters indicate corresponding parts throughout the several views. The exemplification set out herein illustrates an embodiment of the invention in one form, and such exemplification is not to be construed as limiting the scope of the invention in any manner.

What is claimed:

1. A dual-powered utility vehicle comprising:
a gasoline engine configured to rotate a first axle that rotates at least a first wheel;
an electrical motor configured to rotate a second axle that rotates at least a second wheel;
wherein the at least second wheel also rotates the second axle;
at least one battery connected to the electrical motor;
wherein the vehicle is configured such that when being moved under power from the gasoline engine, the at least second wheel of the electrical drive train is rotated by virtue of its ground contact when the gasoline engine rotates the at least first wheel; and
wherein energy created by the at least second wheel rotating is transferred to the at least one battery to recharge the battery and make available for use by the electrical motor to rotate the at least one second wheel when activated to do so.

2. The dual-powered utility vehicle of claim 1, further an electrical motor controller configured to control the electric motor.

3. The dual-powered utility vehicle of claim 1, further comprising a controller in communication with the motor that includes a regeneration mode that causes any energy created by rotation of the at least second wheel to transfer to the at least one battery to recharge the battery.
